(19) United States
(12) Patent Application Publication
(10) Pub. No.: US 2010/0142442 A1
(43) Pub. Date: Jun. 10, 2010

(54) PROCESSING OF AN EMERGENCY SESSION IN A WIMAX NETWORK

(75) Inventors: Ravi Pandey, Masala (FI); Roman Pichna, Espoo (FI); Sami Ilari Makelainen, Helsinki (FI); Zexian Li, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/513,053

(22) PCT Filed: Oct. 30, 2007
(86) PCT No.: PCT/EP07/09410

§ 371 Date: Jan. 29, 2010

Related U.S. Application Data
(60) Provisional application No. 60/855,128, filed on Oct. 30, 2006.

(51) Int. Cl. H04W 40/00; H04W 4/22

(52) U.S. Cl. 370/328; 455/404.1

(57) ABSTRACT

In a system for processing an emergency session in a WiMAX (worldwide interoperability for microwave access) network system including a home network, at least one roaming network and at least one mobile station, an emergency call is established between the mobile station and the home network in case the mobile station is located in the home network, or between the mobile station and a roaming network (visited network) in case the mobile station is located in the roaming network. In a different embodiment, the location of a mobile station is determined in response to an emergency location request and the location (geographic) coordinates are provided in order to establish an emergency call setup.

### FIELD OF THE INVENTION

The present invention relates to a processing of an emergency session in a WiMAX network including at least one mobile station.

### BACKGROUND OF THE INVENTION

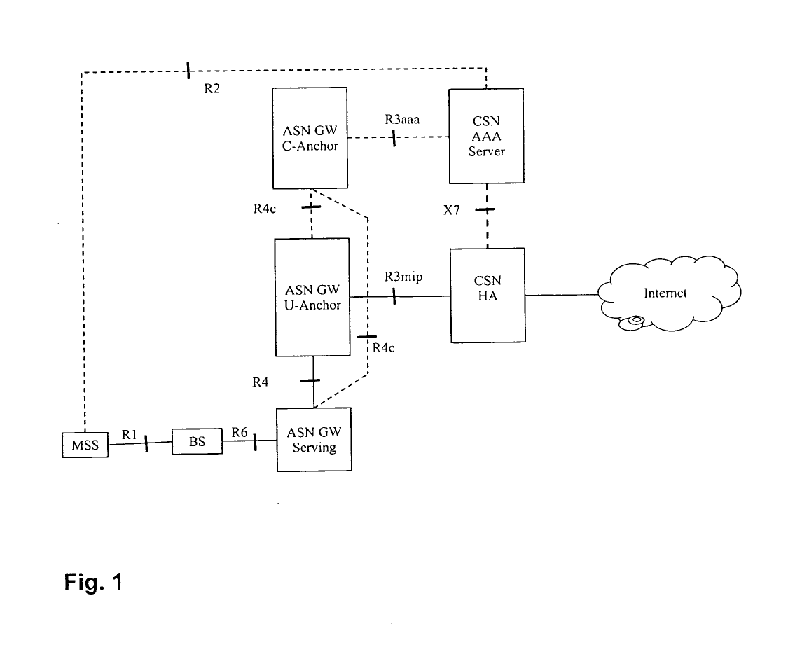

FIG. 1 shows a Network Reference Model (NRM) which is a logical representation of a worldwide interoperability for microwave access (WiMAX) network architecture. The NRM identifies functional entities and reference points over which interoperability is achieved between functional entities. The NRM as shown in FIG. 1 consists of the following logical entities: Mobile Subscriber Station (MSS), Access Service Network (ASN) and Connectivity Service Network (CSN) which are described in greater detail below.

Each of the entities MS, ASN and CSN represent a grouping of functional entities. Each of these functions may be realized in a single physical device or may be distributed over multiple physical devices. The grouping and/or distribution of functions into physical devices within a functional entity (such as ASN) is a matter of an implementation choice. A manufacturer may choose any physical implementation of functions, either individually or in combination, as long as the implementation meets the functional and interoperability requirements.

The Access Service Network (ASN) is defined as a complete set of network functions needed to provide radio access to a WiMAX subscriber, and comprises network elements such as one or more Base Station(s) (BS) and one or more ASN gate way(s) (ASN GW). The ASN provides the following mandatory functions:
WiMAX Layer-2 (L2) connectivity with the WiMAX MSS;
Transfer of Authentication, Authorization and Accounting (AAA) messages to WiMAX subscriber's Home Network Service Provider (H-NSP) for authentication, authorization and session accounting for subscriber sessions;
Network discovery and selection of an appropriate Network Service Provider (NSP) that WiMAX subscriber accesses WiMAX service(s) from;
Relay functionality for establishing Layer-3 (L3) connectivity with a WiMAX MSS, i.e. Internet Protocol (IP) address allocation;
Radio Resource Management;
ASN-CSN tunneling;

In addition to the above mandatory functions, for a portable and mobile environment, an ASN shall support the following functions:
ASN anchor mobility
CSN anchor mobility
Paging and Location Management

An ASN may be shared by more than one Connectivity Service Networks (CSN).

The Connectivity Service Network (CSN) is defined as a set of network functions that provide IP connectivity services to the WiMAX subscriber(s), and may comprise network elements such as routers, AAA proxy/servers, user databases, interworking gateway devices. A CSN may provide the following functions:
MS IP address and endpoint parameter allocation for user sessions;
Internet access;
AAA proxy or server;
Policy and Admission Control based on user subscription profiles;
ASN-CSN tunneling support;
WiMAX subscriber billing and inter-operator settlement;
Inter-CSN tunneling for roaming;
Inter-ASN mobility;
WiMAX services such as location based services, connectivity for peer-to-peer services, provisioning, authorization and/or connectivity to IP multimedia services and facilities to support lawful intercept services such as those compliant with Communications Assistance Law Enforcement Act (CALEA) procedures.

A CSN may be deployed as part of a Greenfield WiMAX NSP or as part of an incumbent WiMAX NSP.

Several interoperability reference points have been incorporated into the NRM shown in FIG. 1. A reference point (RP) is a conceptual point between two groups of functions and resides in different functional entities on either side of it. These functions expose various protocols associated with an RP. All protocols associated with an RP may not always terminate in the same functional entity i.e., two protocols associated with an RP may originate and terminate in different functional entities. The normative reference points between the major functional entities are designated as R1 to R5 in FIG. 1 and explained below in greater detail.

Reference Point R1 consists of the protocols and procedures between MS and ASN as per the air interface (PHY and MAC) specifications (IEEE P802.16e-2005 and IEEE P802.16-2004). Reference point R1 may include additional protocols related to the management plane.

Reference Point R2 consists of protocols and procedures between the MS and CSN associated with Authentication, Services Authorization and IP Host Configuration management. This reference point is logical in that it does not reflect a direct protocol interface between MS and CSN. The authentication part of reference point R2 runs between the MS and the CSN operated by the home NSP. However, the ASN and CSN operated by the visited NSP may partially process the aforementioned procedures and mechanisms. Further, reference Point R2 might support IP Host Configuration Management running between the MS and the CSN (operated by either the home NSP or the visited NSP).

Reference Point R3 consists of a set of control plane protocols between the ASN and the CSN to support AAA, policy enforcement and mobility management capabilities. It also encompasses bearer plane methods (e.g., tunnelling) to transfer user data between the ASN and the CSN.

Reference Point R4 consists of a set of Control and Bearer plane protocols originating/terminating in various functional entities of an ASN that coordinate MS mobility between ASNs and ASN-GWs. R4 is the only interoperable RP between similar or heterogeneous ASNs.

Reference Point R5 consists of a set of control plane and bearer plane protocols for inter-networking between the CSN operated by the home NSP and that operated by a visited NSP.

In most of the networks, an emergency service is required which is considered as a non-subscription based service, provided by the network operator (NSP) or third party IP service providers (ASP). This service does not require explicit authentication and authorization of a Caller.

### SUMMARY OF THE INVENTION

In accordance with a first aspect of the present invention, there is provided a system for processing an emergency session in a WiMAX (worldwide interoperability for microwave access) network system including a home network, at least one roaming network and at least one mobile station wherein an emergency call is established between the mobile station and the home network in case the mobile station is located in the home network, or between the mobile station and a roaming network in case the mobile station is located in the roaming network.

In accordance with a second aspect of the present invention, there is provided a method for processing an emergency session in a WiMAX (worldwide interoperability for microwave access) network system including a home network, at least one roaming network and at least one mobile station wherein an emergency call is established between the mobile station and the home network in case the mobile station is located in the home network, or between the mobile station and a roaming network in case the mobile station is located in the roaming network.

Preferably, the mobile station indicates the cause “emergency call”.

The emergency call may be established between the mobile station and the nearest network element of the network in which the mobile station is located.

Preferably, the mobile station located in a roaming network, but still registered to the home network carries out a de-registration from the home network and a re-registration to the roaming network for emergency call. In an alternative preferred embodiment, in case the mobile station located in a roaming network, but still registered to the home network forwards a request for an emergency session to the home network, the home network rejects said request, and in response thereto the mobile station carries out a de-registration from the home network and a re-registration to the roaming network for emergency call.

Moreover, the location of the mobile station may be determined in response to an emergency location request, and location coordinates of the mobile station may be provided for setup of an emergency call.

In accordance with third aspect of the present invention, there is provided a mobile station in a WiMAX network system including a home network and at least one roaming network, comprising a transmitter for sending an emergency call, wherein said transmitter is adapted to forward the emergency call to the home network in case the mobile station is located in the home network, or to a roaming network in case the mobile station is located in the roaming network.

In accordance with a fourth aspect of the present invention, there is provided a system for processing an emergency session in a WiMAX network including at least one mobile station, comprising a location network element for determining the location of the mobile station in response to an emergency location request from the mobile station or from the network and for providing the location coordinates of the mobile station to be used in an emergency call setup signalling.

In accordance with a fifth aspect of the present invention, there is provided a network element in a WiMAX network including at least one mobile station, wherein the network element is a location network element for determining the location of the mobile station in response to an emergency location request from the mobile station or from the network and providing location coordinates of the mobile station to be used in an emergency call setup signalling.

The location network element may use the base station ID, raw positioning data and/or the mobile station's internet protocol (IP) address for determining the location of the mobile station and providing the location coordinates of the mobile station. Preferably, in case the mobile station has initiated an emergency location update, the location network element may receive the base station ID and/or raw positioning data from an access serves network gateway (ASN GW) or an authentication, authorisation and accounting (AAA) server, and may receive the mobile station's IP address directly from the mobile station. In case a network, in particular an IMS Core, has initiated an emergency location update, the location network element may receive the mobile station's IP address directly from said network. Additionally or alternatively, for determining the location of the mobile station the location network element may carry out a triangulation calculation or a base station ID-to-location mapping.

Preferably, the location network element forwards the location coordinates of the mobile station to the ASN GW or AAA server.

In accordance with a sixth aspect of the present invention, there is provided a method for processing an emergency session in a WiMAX network including at least one mobile station, comprising the steps of determining the location of the mobile station in response to an emergency location request and providing location coordinates of the mobile station to be used in an emergency call setup signalling.

In accordance with a seventh aspect of the present invention, there is provided a mobile station in a WiMAX network, comprising a transmitter for sending an emergency location request message, a receiver for receiving its own location coordinates, and an emergency call setup signaller adapted to process said location coordinates.

In accordance with a eighth aspect of the present invention, there is provided a method for the mobile station to initiate a location update in a WiMAX network, comprising the steps of sending an emergency location request message, receiving its own location coordinates, and processing the location coordinates in an emergency call setup signalling.

The mobile station may send the emergency location request message to the serving base station from which it will receive the location coordinates.

Alternatively, the mobile station sends the emergency location request message directly to the location network element from which it will receive the location coordinates.

In a roaming case when an emergency location update is requested with a home agent (HA) in the home network, the roaming mobile station preferably sends the emergency location request message with a source IP address to a home location network element from which it will receive the location coordinates.

In a further roaming case when an emergency location update is requested with a home agent in a visited network, the mobile station preferably sends the emergency location request message to the visited location network element from which it will receive the location coordinates.

Accordingly, since it has been found that a caller location plays a central roll in routing emergency calls, it is an advantage of the present invention to provide the location information of the mobile station during an emergency session. A further advantage of the present invention is to provide an emergency session call routing from a home network to a visited network for a roaming user.

### BRIEF DESCRIPTION OF PREFERRED EMBODIMENTS

FIG. 1 shows a conventional WiMAX network reference model;

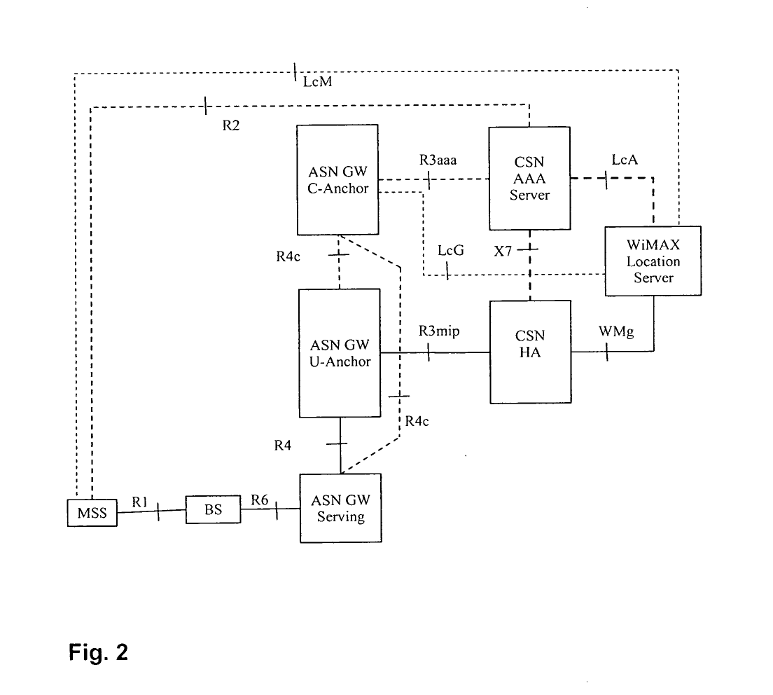

FIG. 2 shows a WiMAX network reference model in accordance with a first embodiment of the present invention wherein a mobile station initiates an emergency location update;

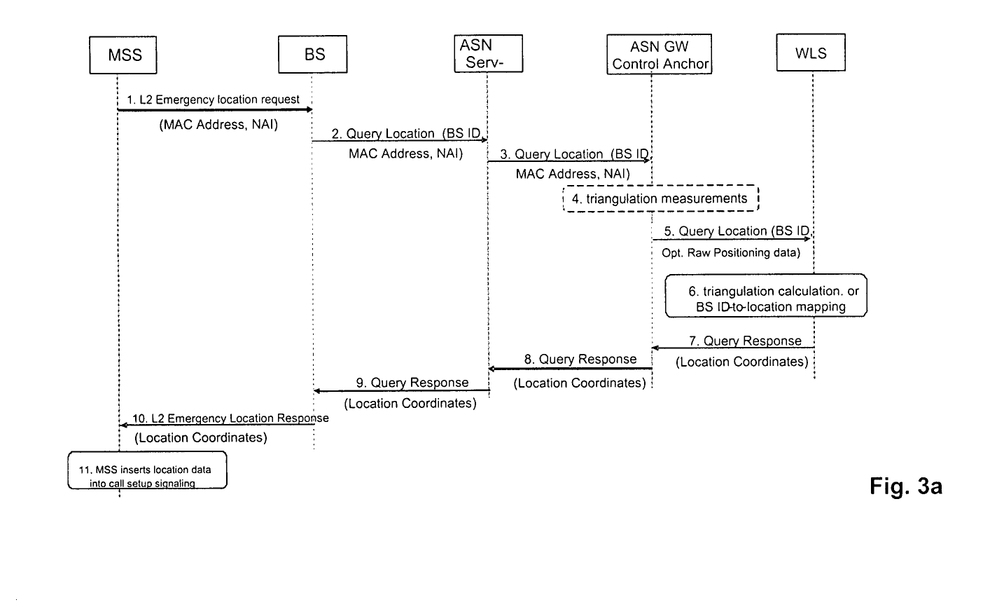

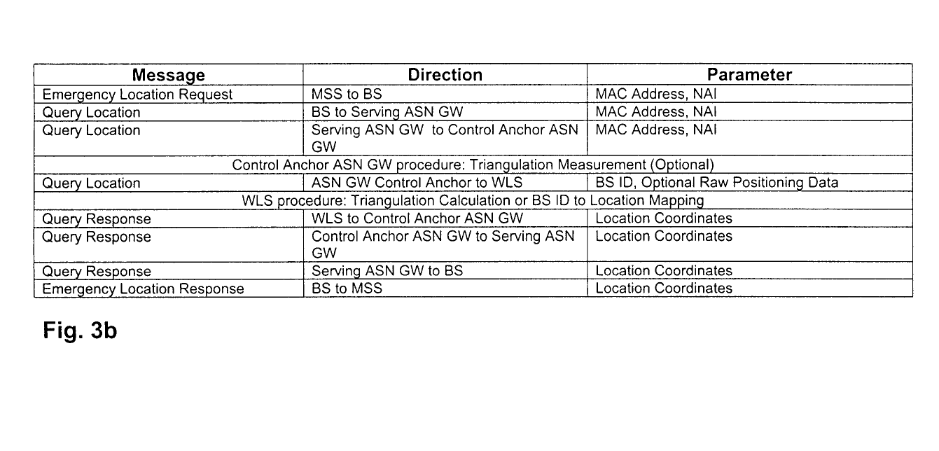

FIG. 3 shows a flow diagram (a) and a table (b) of a method to request for an emergency location update with L2 emergency location message by a mobile station in accordance with the first embodiment of the present invention;

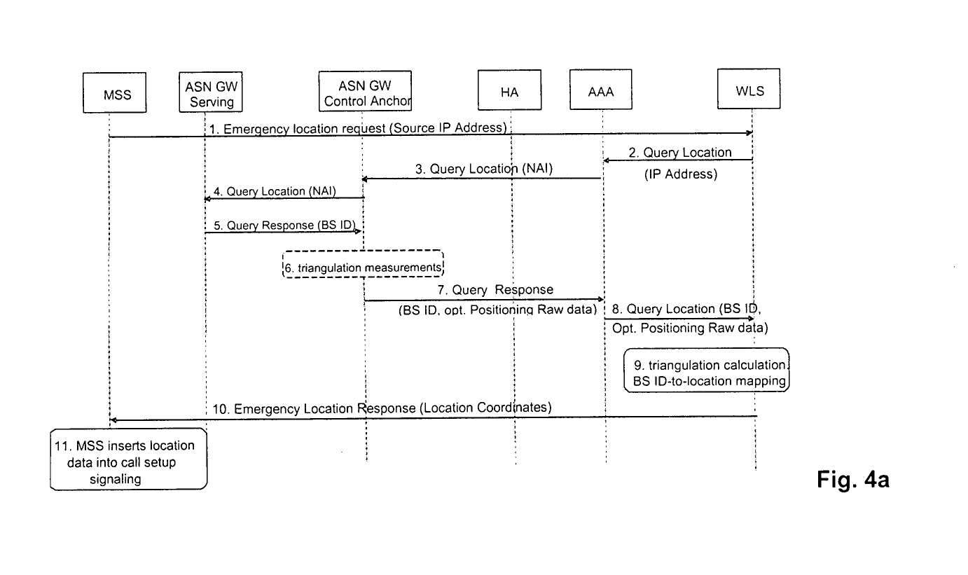

FIG. 4 shows a flow diagram (a) and a table (b) of a method to request for an emergency location update above L3 (IP) by a mobile station in a non-roaming case in accordance with the first embodiment of the present invention;

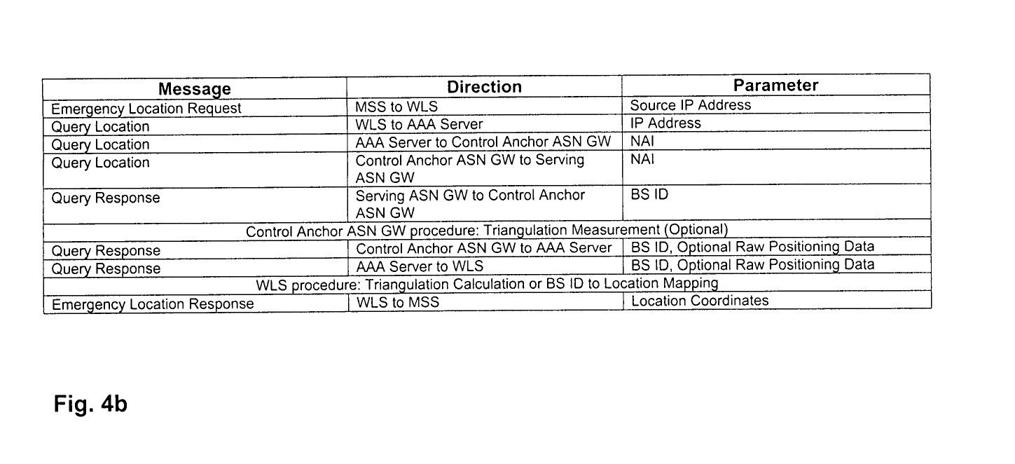

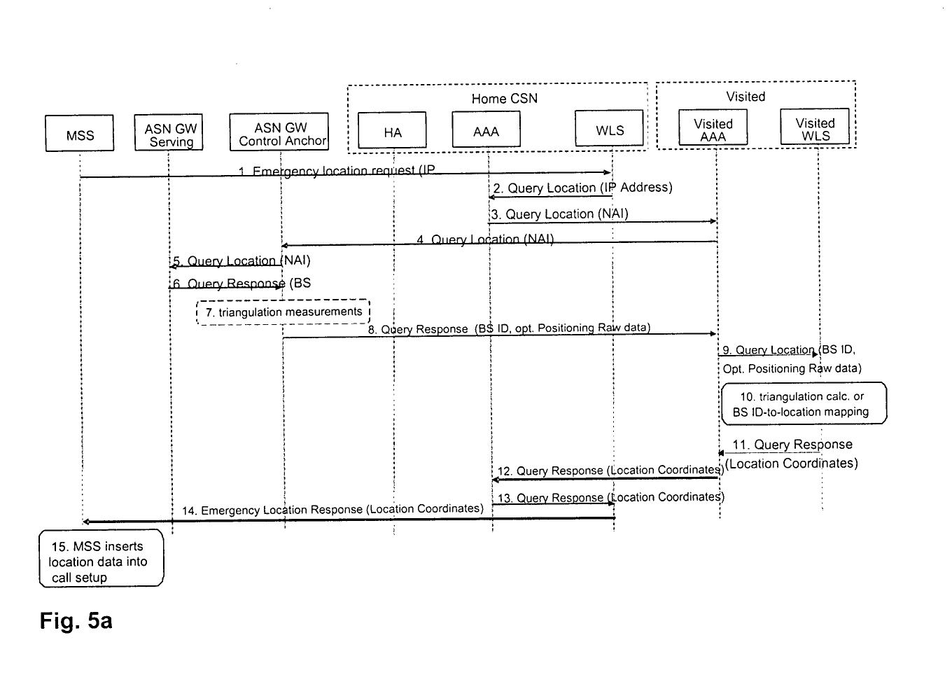

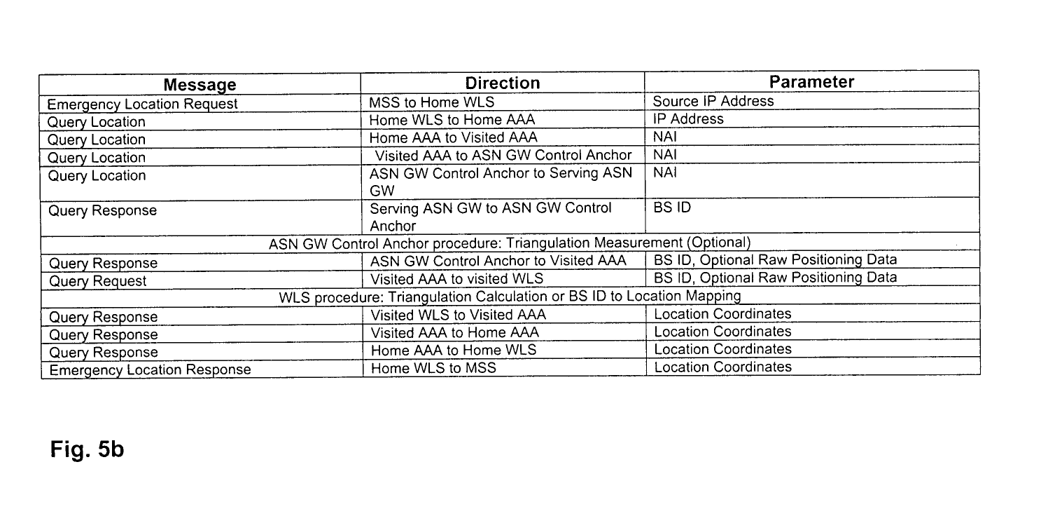

FIG. 5 shows a flow diagram (a) and a table (b) of a method to request for emergency location update with a home agent in the home network by a mobile station in a roaming case in accordance with the first embodiment of the present invention;

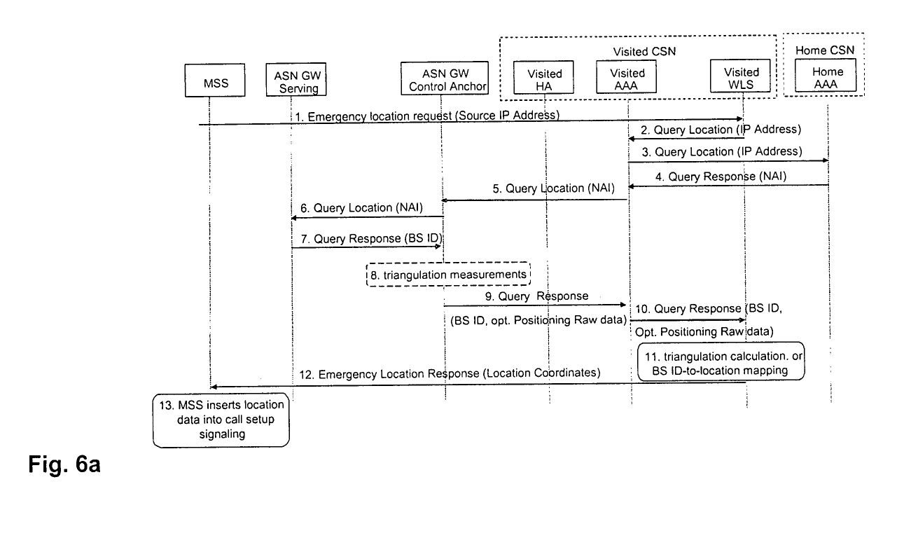

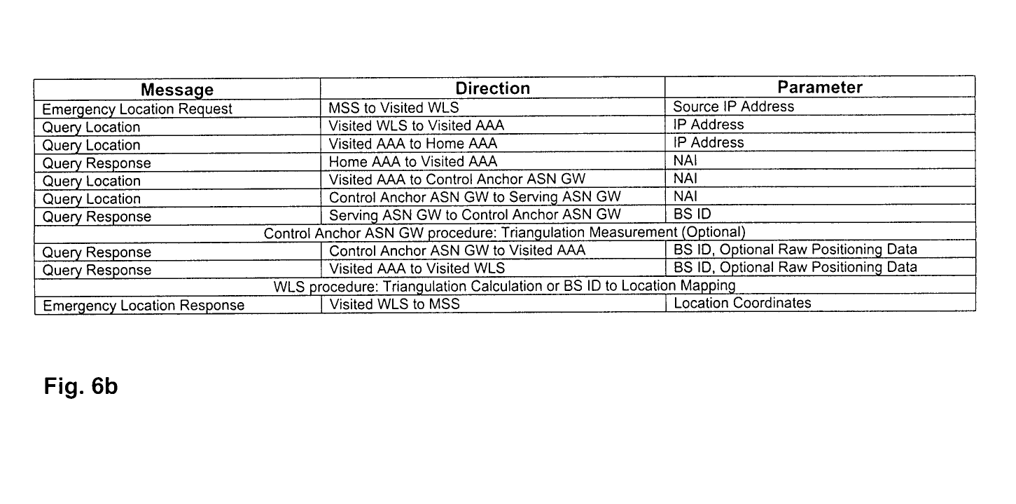

FIG. 6 shows a flow diagram (a) and a table (b) of a method to request for emergency location update with a home agent in a visited network by a mobile station in a roaming case in accordance with the first embodiment of the present invention;

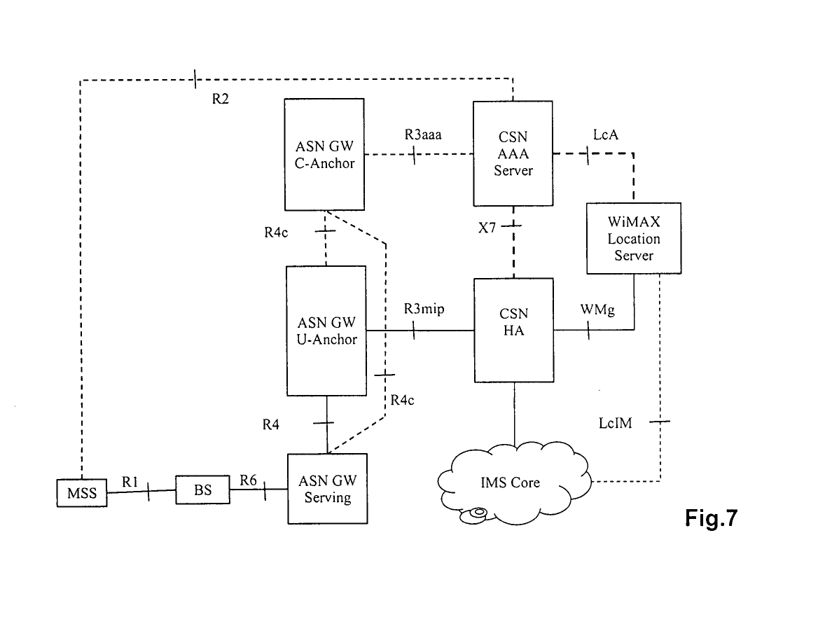

FIG. 7 shows a WiMAX network reference model in accordance with a second embodiment of the present invention wherein a network initiates an emergency location update;

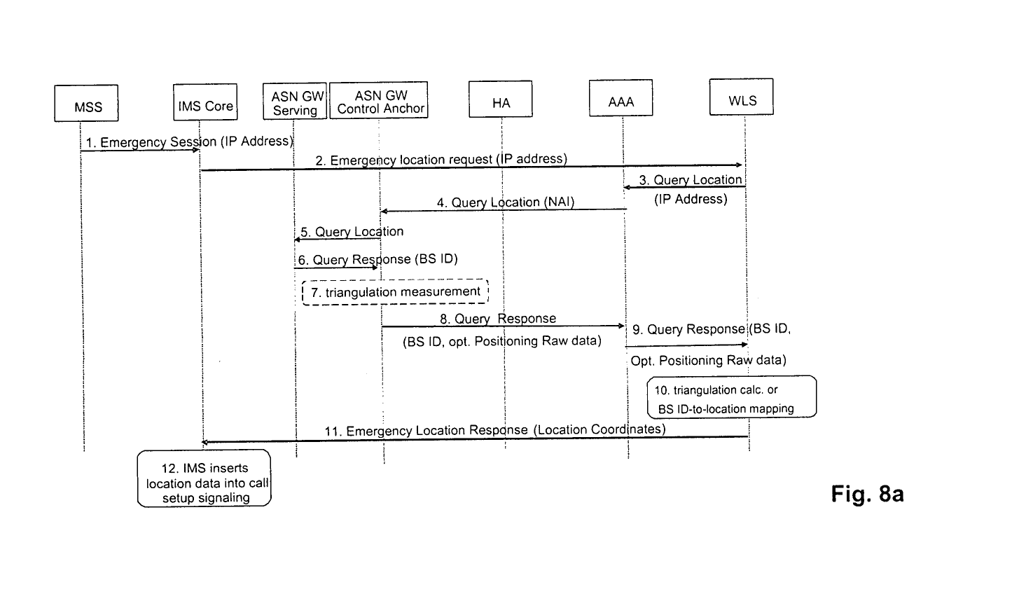

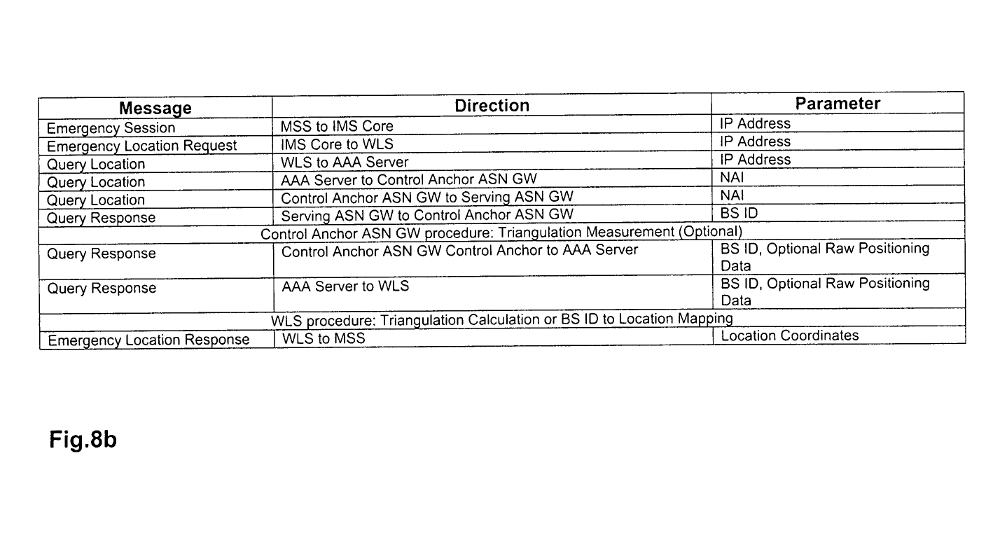

FIG. 8 shows a flow diagram (a) and a table (b) of a method to request for an emergency location update by a network in a non-roaming case in accordance with the second embodiment of the present invention;

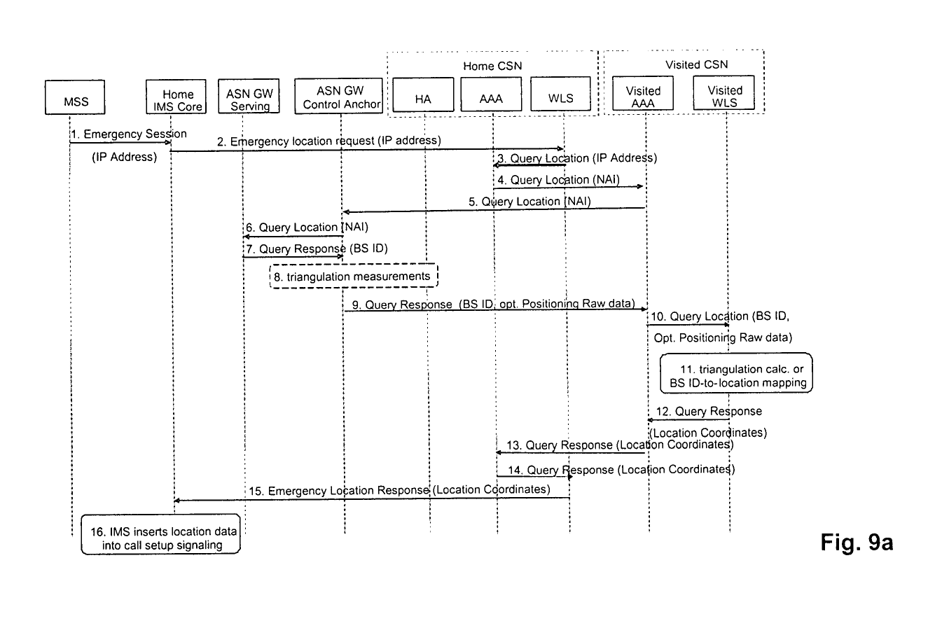

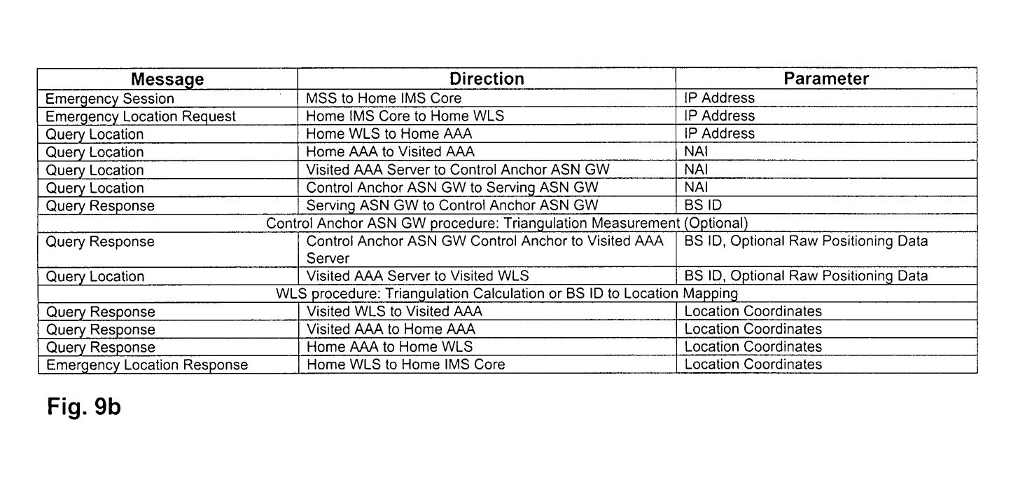

FIG. 9 shows a flow diagram (a) and a table (b) of a method to request for an emergency location update by a home network in a roaming case in accordance with the second embodiment of the present invention;

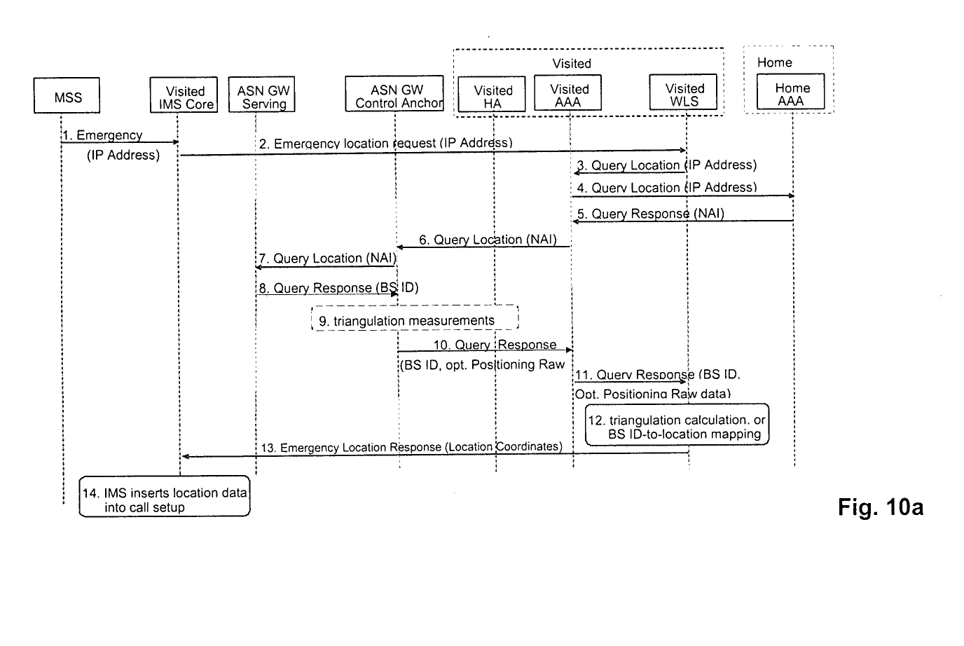

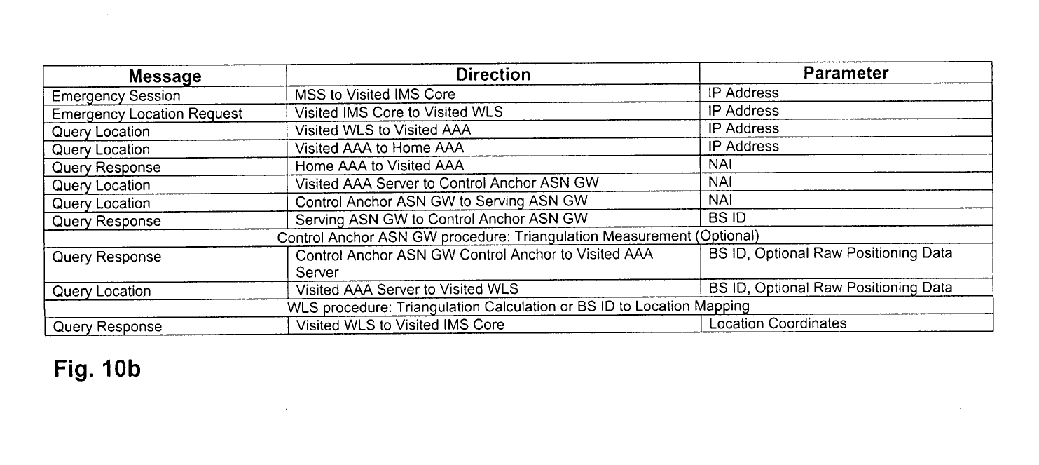

FIG. 10 shows a flow diagram (a) and a table (b) of a method to request for an emergency location update by a visited network in a roaming case in accordance with the second embodiment of the present invention;

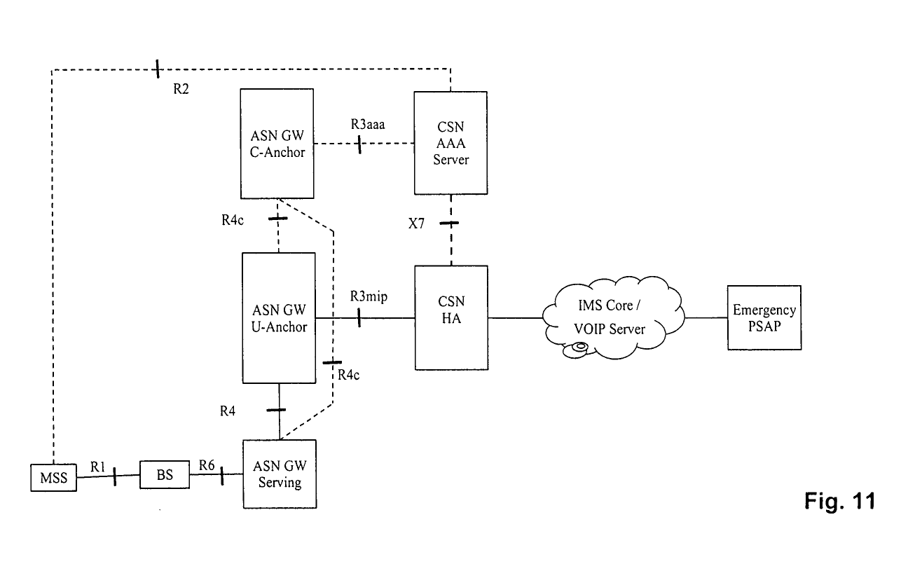

FIG. 11 shows a WiMAX reference model in accordance with a third embodiment of the present invention wherein an emergency call for a roaming user is established;

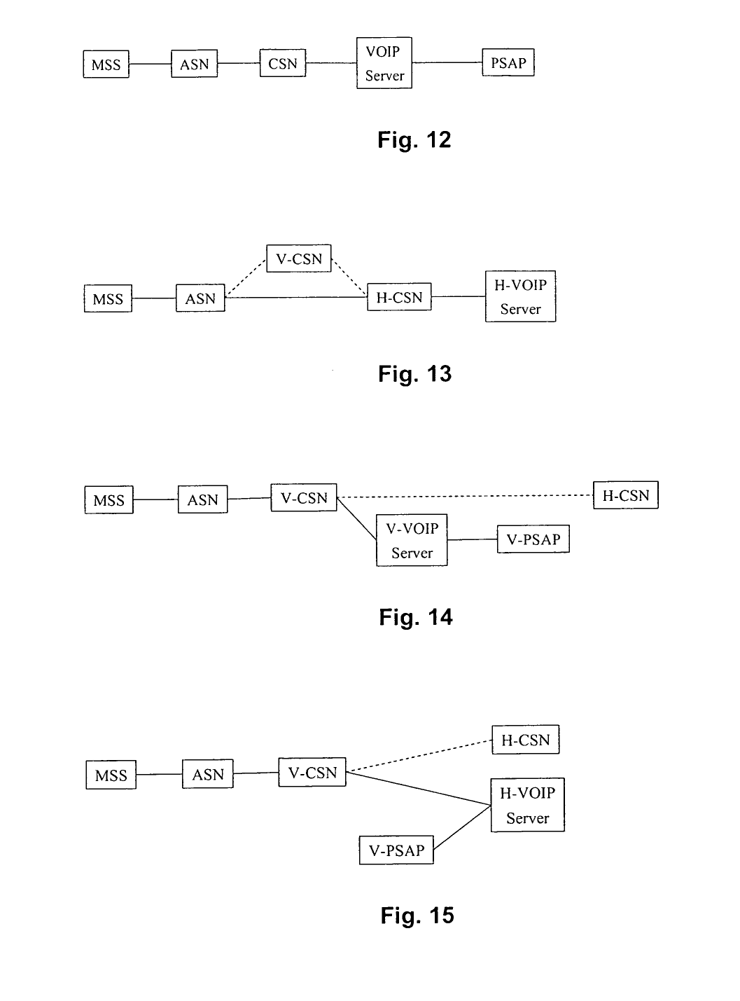

FIG. 12 shows a scheme of a non-roaming case in accordance with the third embodiment of the present invention where the mobile station is located in a home network;

FIG. 13 shows a scheme of a roaming case in accordance with the third embodiment of the present invention where the mobile station is located in a visited network;

FIG. 14 shows a scheme of a further roaming case in accordance with the third embodiment of the present invention where the mobile station is located in a visited network;

FIG. 15 shows a scheme of a still further roaming case in accordance with the third embodiment of the present invention where the mobile station is located in the visited network;

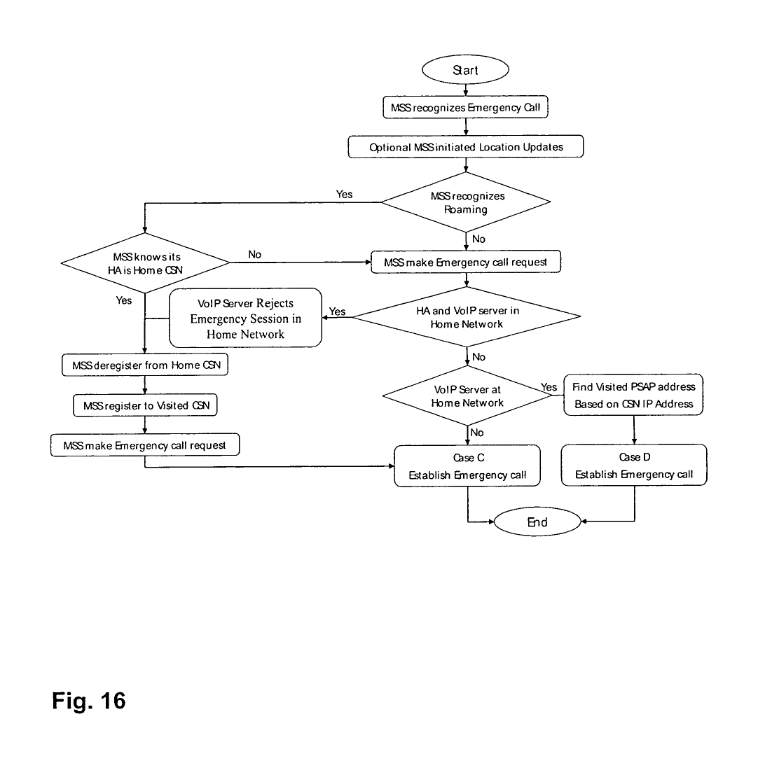

FIG. 16 shows a flow diagram wherein the schemes of the FIGS. 12 to 15 are combined; and

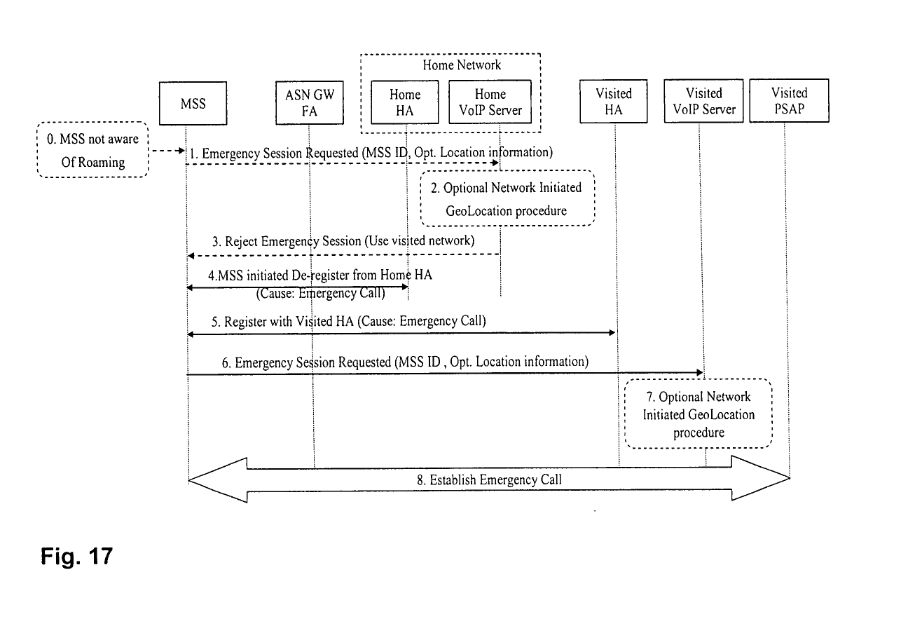

FIG. 17 shows a flow diagram of a method for implementation of the scheme of FIG. 13.

### DESCRIPTION OF THE PREFERRED EMBODIMENT

### First Embodiment

This embodiment deals with the provision of a local information during emergency sessions and provides a method to enable a mobile subscriber station to initiate an emergency location update in WiMAX network access. The target is to define a lightweight location solution.

FIG. 2 shows a WiMAX Network Reference Model (NRM) in accordance with the first embodiment which is modified over the NRM of FIG. 1 by incorporating a new logical element called WiMAX Location Server (WLS) and new reference points “LcA” towards the CSN/AAA server, “LcG” towards the ASN GW Control Anchor, “LcM” towards the MSS and “WMg” towards the CSN Home Agent (HA).

The WiMAX Location Server (WLS) is a logical network element in WiMAX architecture. The primary functions of the WLS in the embodiment are as follows:
Receipt of a location query message from the ASN GW or the AAA server which message provides the BS ID, and/or optionally Raw Positioning Data, as input, or receipt of a location query message from the MSS directly which message provides the MSS IP address.
Triangulation calculation or BS ID-to-location mapping.
Provision of a Query Response message including location coordinates of the MSS to the ASN GW or AAA server.

With respect thereto, it is to be noted that triangulation measurement is an optional step performed by the Control Anchor ASN GW.

During emergency session, the MSS location plays a central role in routing the emergency call and locating the caller. The first embodiment covers the case where the MSS requests for emergency location updates from the WiMAX access network.

In the following, four different optional examples of a method for requesting emergency location updates by the MSS according to the first embodiment are described.

The first example deals with a request for an emergency location update with an L2 emergency location message, wherein the method which is shown in FIG. 3 in terms of a flow diagram (FIG. 3a) and a table (FIG. 3b) includes the following steps:
1. The MSS sends an L2 Emergency Location Request message with a MAC address and Network Access Identifier (NAI) to the serving BS.
2. On the basis of the received L2 Emergency Location Request message, the serving BS creates a location query message by adding the BS ID (=Sector ID) to the MAC address and the NAI and forwards the location query message to the serving ASN GW.
3. The serving ASN GW forwards the location query message to the Control Anchor ASN GW.
4. Optionally, the Control Anchor ASN GW provides raw positioning data on the basis of the location query received, preferably by initiating a triangulation measurement.
5. The Control Anchor ASN GW forwards the location query message including the BS ID (Sector ID) (and optionally the raw positioning data) to the WLS for further calculation.
6. The WLS calculates location coordinates based on the BS ID (Sector ID) (and optionally raw positioning data) and creates a Query Response message, accordingly.
7. The WLS sends the Query Response message with the location coordinates to the Control Anchor ASN GW
8. The Control Anchor ASN GW sends the Query Response message with the location coordinates to the serving ASN GW.
9. The serving ASN GW sends the Query Response message with the location coordinates to the Serving BS.
10. The serving BS forwards the received Query Response message as L2 Emergency Location Response message with the location coordinates to the MSS.
11. The MSS uses the location information in an emergency call setup signalling.

The second example deals with a request for an emergency location update above L3 (IP) in a non-roaming case. In order to have a direct communication between the MSS and the WLS, the WLS address is either pre-configured in the MSS or resolved by a DNS query.

The method of this example which is shown in FIG. 4 terms of a flow chart (FIG. 4a) and a table (FIG. 4b) includes the following steps:
1. The MSS sends an Emergency Location Request message to the WLS.
2. The WLS provides a location query message to the AAA server using the source IP address of the emergency location request message as MSS ID.
3. The AAA server maps the IP address to NAI and provides the location query message including the NAI to the ASN GW control anchor.
4. The Control anchor ASN GW sends the location query message to the serving ASN GW.
5. On the basis of the query location message, the serving ASN GW provides a Query Response message including the BS ID (=Sector ID) and sends it to the Control Anchor ASN GW.
6. Optionally, the Control Anchor ASN GW provides raw positioning data on the basis of the query location message received, preferably by initiating a triangulation measurement.
7. The Control Anchor ASN GW sends the Query Response message with the BS ID (and optionally raw positioning data) to the AAA server.
8. The AAA server sends the Query Response message as query location message with the BS ID (and optionally raw positioning data) to the WLS.
9. The WLS calculates location coordinates based on the BS ID (=Sector ID) (and optionally raw positioning data).
10. The WLS sends an Emergency Location Response message with the calculated location coordinates to the MSS.
11. The MSS uses the location information in the emergency call setup signalling.

The third example deals with a request for emergency location update with a home agent (HA) in the home network in a roaming case, wherein the method which is shown in FIG. 5 in terms of a flow chart (FIG. 5a) and a table (FIG. 5b) includes the following steps:
1. The roaming MSS sends an Emergency Location Request message with a source IP address to a Home WLS.
2. The WLS provides a location query message to a Home AAA server using the IP address.
3. The Home AAA server maps the IP address to NAI and provides the location query message including the NAI to the AAA server in a visited network.
4. The visited AAA server provides the location query message to the Control Anchor ANS GW.
5. The Control Anchor ASN GW provides the location query message to the serving ASN GW.
6. On the basis of the location query message including the NAI, the serving ASN GW provides a Query Response message including the BS ID (=Sector ID) and sends it to the Control Anchor ASN GW.
7. Optionally, the Control Anchor ASN GW provides raw positioning data, preferably by initiating a triangulation measurement.
8. The Control Anchor ASN GW sends the Query Response message with the BS ID (and optionally raw positioning data) to the visited AAA server.
9. The visited AAA server sends the Query Response message to the visited WLS.
10. A location calculation is performed in the visited network by the visited WLS in order to provide location coordinates in the query response message.
11. The visited WLS sends the Query Response message with the location coordinates to the visited AAA server.
12. The visited AAA server sends the Query Response message with the location coordinates to the Home AAA server.
13. The Home AAA server sends the Query Response message with the location coordinates to the Home WLS server.
14. The Home WLS forwards the received Query Response message as Emergency Location Response message with the location coordinates to the MSS.
15. The MSS uses the location information in the emergency call setup signalling.

The fourth example deals with a request for emergency location update with a home agent in a visited network in a roaming case. In order to have a direct communication between the MSS and the WLS, the WLS address is either pre-configured in the MSS or resolved by a DNS query. The method of this example which is shown in FIG. 6 in terms of a flow chart (FIG. 6a) and a table (FIG. 6b) includes the following steps:
1. The MSS sends an Emergency Location Request message to the visited WLS.
2. The visited WLS provides a location query message to the visited AAA server using the source IP address of the message as MSS ID.
3. The visited AAA provides the location query message including the source ID address to the Home AAA server.
4. The Home AAA server maps the source IP address to NAI and provides a Query Response message including the NAI to the visited AAA server.
5. On the basis of the Query Response message received, the visited AAA server provides a location query message including the NAI to the Control Anchor ASN GW.
6. The Control Anchor ASN GW provides the location query message to the serving ASN GW.
7. On the basis of the location query message including the NAI, the serving ASN GW provides a Query Response message including the BS ID (=Sector ID) and sends it to the Control Anchor ASN GW.
8. Optionally, the Control Anchor ASN GW provides raw positioning data, preferably by initiating a triangulation measurement.
9. The Control Anchor ASN GW sends the Query Response message with the BS ID (and optionally raw positioning data) to the visited AAA server.
10. The visited AAA server sends the Query Response with the BS ID (and optionally raw positioning data information) to the visited WLS.
11. The visited WLS calculates location coordinates based on the BS ID (=Sector ID) (and optionally raw positioning data).
12. The visited WLS sends an Emergency Location Response message with the calculated location coordinates to the MSS.
13. The MSS uses the location information in the emergency call setup signalling.

### Second Embodiment

This embodiment deals with the provision of a local information during emergency sessions and provides a method to enable a network to initiate an emergency location update in WiMAX network access. The target is to define a lightweight location solution.

FIG. 7 shows a WiMAX Network Reference Model (NRM) in accordance with the second embodiment which is modified over the NRM of FIG. 1 by incorporating a new logical element called WiMAX Location Server (WLS) and new reference points “LcA” towards the CSN/AAA server, “LcIM” towards an internet protocol multimedia subsystem (IMS) Core and “WMg” towards the CSN HA. So, the NRM of the second embodiment differs from the NRM of the first embodiment by the additional use of an IMS Core and the provision of the reference point “LcIM” instead of reference points “LcG” and “LcM”.

Here again, the WiMAX Location Server (WLS) is a logical network element in WiMAX architecture. The primary functions of the WLS in this embodiment are as follows:
Receipt of a location query message from the IMS Core which message provides the MSS IP address as input.
Triangulation calculation or BS ID-to-location mapping.
Provision of a Query Response message including location coordinates of the MSS to the ASN GW or AAA server.

With respect thereto, it is to be noted that triangulation measurement is an optional step performed by the Control Anchor ASN GW.

During emergency session, the location of the MSS plays a central role in routing the emergency call and locating the caller. The second embodiment covers the case where the IMS Core requests for emergency location updates from WiMAX Location Server, and the network determines the location, if the MSS does not provides its location.

In the following, three different optional examples of a method for requesting emergency location updates by the network according to the second embodiment are described.

The first example deals with a request for an emergency location update in a non-roaming case wherein the method which is shown in FIG. 8 in terms of a flow diagram (FIG. 8a) and a table (FIG. 8b) includes the following steps:
1. The MSS sends an emergency session message without location information to IMS Core.
2. The IMS Core initiates an Emergency Location Request message including the IP address and sends it to the WLS.
3. On the basis of the received Emergency Location Request message, the WLS creates a location query message using the IP address and forwards the location query message to the AAA server.
4. The AAA server maps the IP address to the NAI and provides the location query message now including the NAI to the Control Anchor ASN GW.
5. The Control Anchor ASN GW forwards the location query message to the serving ASN GW.
6. On the basis of the received location query message including the NAI, the serving ASN GW creates a Query Response message including the BS ID (=Sector ID) and sends it to the Control Anchor ASN GW.
7. Optionally, the Control Anchor ASN GW provides raw positioning data on the basis of the Query Response message, preferably by initiating a triangulation measurement.
8. The Control Anchor ASN GW forwards the Query Response message including the BS ID (and optionally raw positioning data) to the AAA server.
9. The AAA Server sends the Query Response message with the BS ID (and optionally raw positioning data) to the WLS.
10. The WLS provides location coordinates (and optionally raw positioning data) by a triangulation calculation or by a BS ID to location mapping and creates an emergency location response message including the location coordinates.
11. The WLS forwards the emergency location response message back to the IMS Core.
12. The IMS Core uses the location information in the emergency call setup signalling.

The second example deals with a request for an emergency location update by a home network in a roaming case, wherein the method which is shown in FIG. 9 in terms of a flow diagram (FIG. 9a) and a table (FIG. 9b) includes the following steps:
1. The MSS sends an emergency session message to the Home IMS Core wherein this message includes the IP address, but does not include any location information.
2. The Home IMS Core initiates an Emergency Location Request message including the IP address and sends it to the Home WLS.
3. On the basis of the received Emergency Location Request message, the Home WLS creates a location query message using the IP address and forwards the location query message to the AAA server.
4. The Home AAA server maps the IP address to NAI and provides a location query message including the NAI to the Visited AAA server.
5. The visited AAA server forwards the location query message to the Control Anchor ASN GW.
6. The Control Anchor ASN GW forwards the location query message to the serving ASN GW.
7. On the basis of the received location query message including the NAI, the serving ASN GW creates a Query Response message including the BS ID (=Sector ID) and sends it to the Control Anchor ASN GW.
8. Optionally, the Control Anchor ASN GW provides raw positioning data on the basis of the Query Response message, preferably by initiating a triangulation measurement.
9. The Control Anchor ASN GW forwards the Query Response message including the BS ID (and optionally raw positioning data) to the visited AAA server.
10. The visited AAA Server sends the Query Response message with the BS ID (and optionally raw positioning data) to the visited WLS.
11. The visited WLS provides location coordinates (and optionally raw positioning data) by a triangulation calculation or by a BS ID to location mapping and creates an emergency location response message including the location coordinates.
12. The visited WLS forwards the emergency location response message back to the visited AAA server.
13. The visited AAA server sends the Query Response message to the Home AAA server.
14. The Home AAA server sends the Query Response message to the Home WLS.
15. On the basis of the received query response message, the Home WLS creates an Emergency Location Response message including the location coordinates and sends it to the Home IMS Core.
16. The Home IMS Core uses the location information in the emergency call setup signalling.

The third example deals with a request for an emergency location update by a visited network in a roaming case, wherein the method which is shown in FIG. 10 in terms of a flow diagram (FIG. 10a) and a table (FIG. 10b) includes the following steps:
1. The MSS sends an emergency session message to the visited IMS Core wherein this message includes the IP address, but does not include any location information.
2. The visited IMS core initiates an Emergency Location Request including the IP address and sends it to the visited WLS.
3. On the basis of the received Emergency Location Request message, the visited WLS creates a location query message using the IP address and forwards the location query message to the AAA server.
4. The visited AAA forwards the location query message to the Home AAA server.
5. The Home AAA server maps the IP address to the NAI and provides a location query message including the NAI to the visited AAA server.
6. The visited AAA server forwards the location query message to the Control Anchor ASN GW.
7. The Control Anchor ASN GW forwards the location query message to the serving ASN GW.
8. On the basis of the received location query message including the NAI, the serving ASN GW creates a Query Response message including the BS ID (=Sector ID) and sends it to the Control Anchor ASN GW.
9. Optionally, the Control Anchor ASN GW provides raw positioning data on the basis of the Query Response message, preferably by initiating a triangulation measurement.
10. The Control Anchor ASN GW forwards the Query Response message including the BS ID (and optionally raw positioning data) to the visited AAA server.
11. The visited AAA server sends the Query Response message with the BS ID (and optionally raw positioning data) to the visited WLS.
12. The visited WLS provides location coordinates (and optionally raw positioning data) by a triangulation calculation or by a BS ID to location mapping and creates an emergency location response message including the location coordinates.
13. The visited WLS sends the Emergency Location Response message to the visited IMS Core.
14. The visited IMS Core uses the location information in the emergency call setup signalling.

With respect to the above described third example, it should be added that, if the HA is in the visited CSN (V-CSN), the visited AAA server (V-AAA) may know the IP address so that NAI mapping and then steps 4 and 5 are not needed.

### Third Embodiment

This embodiment deals with the establishment of an emergency call for a roaming user in a WiMAX network access.

FIG. 11 shows a WiMAX Network Reference Model (NRM) in accordance with the third embodiment which is modified over the NRM of FIG. 1 by using an IMS Core/Voice-over-IP (VOIP) Server in the internet and an Emergency Public Service Answering Point (PSAP). The VOIP Server and IMS Core are considered part of a VOIP infrastructure which provides a SIP proxy. There can be a Public Switched Telephone Network (PSTN) GW (or a similar element) between the VOIP server and the PSAP for the SIP-based VOIP infra-structure.

In the following, four different optional examples of a method for establishing an emergency session according to the third embodiment are described.

FIG. 12 shows a non-roaming case where the MSS is located in a Home network, and in case of emergency an emergency call is established between the nearest PSAP and the MSS. The MSS can optionally provide the geographical location information. Alternatively, the VOIP server resolves the location information.

FIG. 13 shows a roaming case where the MSS is located in a visited network and connected to a Home CSN (as Home Agent) and a Home VOIP Server. In case of emergency call, there are the two possible scenarios:
The MSS recognizes a roaming and initiates a de-registration from the Home network and do a re-registration to the visited network for emergency call.
The MSS does not recognize roaming and initiates an Emergency Session Request message to the Home VOIP Server, which in turn identifies the geographical location of MSS as roaming and rejects the request by indicating the error cause “Use Visited Network”. After rejection from the Home network, the MSS initiates a deregistration (cause: Emergency Call) from the Home network and do a re-registration (cause: Emergency Call) to the visited network for emergency call. During re-registration the MSS must indicate the cause “Emergency Call”, otherwise it may end up in the Home HA.

For emergency calls, both the above described scenarios relating to the case of FIG. 13 result in a roaming case as shown in FIG. 14 where the MSS is located in the visited network and connected to the Visited CSN (V-CSN) (as Home Agent) and the Visited VOIP (V-VOIP) Server. In case of emergency, an emergency call is established between the nearest PSAP in the visited network (V-PSAP) and the MSS. The MSS can optionally provide the geographical location information. Alternatively, the visited VOIP server resolves the geographical location information.

FIG. 15 shows a further roaming case where the MSS is located in the visited network and connected to Visited CSN (as Home Agent) and the Home (H-VOIP) VOIP Server. The Visited CSN (V-CSN) should resolve the public IP address of the Home VOIP Server via a DNS query. In case of emergency, an emergency call is made to the Home VOIP server.

Based on the MSS ID and the Visited CSN address, the call is routed to the nearest PSAP in the visited network (V-PSAP). The MSS can optionally provide the geographical location information. Alternatively the Home VOIP Server resolves the geographical location information.

With regard to the above described four cases, it is additionally referred to FIG. 16 wherein the four cases of FIGS. 12 to 15 are combined in a common flow diagram.

FIG. 17 shows a method for the implementation of the case of FIG. 13 wherein it is assumed that the MSS is connected to a Home CSN (Home Agent) and detects an emergency session. This method includes the following steps:
1. The MSS which is not aware of roaming sends an Emergency Session Request message including the MSS ID and optionally geographical location Information to the Home VOIP Server.
2. If the MSS does not provide geographical location information, the Home VOIP Server initiates a geographical location procedure to find the location of the MSS.
3. If the location of the MSS is roaming, the Home VOIP Server denies the emergency services and sends a Reject Emergency Session message by indicating the error cause “Use Visited Network” and location information (if step 2 is executed).
4. The MSS initiates a de-registration from the Home HA with cause “Emergency Session”.
5. The MSS initiates a re-registration with the Visited HA with cause “Emergency Session”.
6. The MSS sends an Emergency Session Request message including the MSS ID and optionally geographical location information to the Visited VOIP Server.
7. If the MSS does not provide geographical location information, the Visited VOIP Server initiates a geographical location procedure to find the location of the MSS
8. The Visited VOIP Server locates the nearest PSAP and establishes an Emergency Call session with the MSS.

However, if the MSS recognizes roaming and knows that the HA is in the Home CSN, the above described method of FIG. 17 can start from step 4 so that the MSS initiates a de-registration as first step.

Finally, it should be noted that the above preferred descriptions are of preferred examples for implementing the present invention, but the scope of the present invention should not necessarily be limited by this description.

1-29. (canceled)

30. A method, comprising:
Performing a de-registration, by a mobile station, from a home network of a worldwide interoperability for microwave access (WiMAX) network system; and
performing a re-registration to a roaming network where the mobile station is currently located; and
sending an emergency call request to the roaming network.

31. The method according to claim 30, further comprising indicating a cause of an emergency call during re-registration to the roaming network.

32. The method according to claim 30, further comprising an emergency call is established between the mobile station and the nearest network element of the roaming network in which the mobile station is currently located.

33. The method according to claim 30, further comprising determining a location of the mobile station in response to an emergency location request, and providing location coordinates of the mobile station for setup of an emergency call.

34. The method of claim 30, further comprising sending an emergency call request to the home network when the mobile station does not recognize roaming before performing de-registration from the home network.

35. The method of claim 34, further comprising receiving rejection of the request from the home network.

36. The method of claim 35, further comprising receiving an indication to use the roaming network where the mobile station is currently located.

37. The method of claim 35, further comprising indicating a cause of an emergency call during re-registration to the roaming network.

38. The method of claim 37, further comprising establishing an emergency call between the mobile station and the nearest network element of the roaming network in which the mobile station is currently located.

39. An apparatus, comprising:
a register configured to:
perform a de-registration from a home network of a worldwide interoperability for microwave access (WiMAX) network system, wherein the apparatus is registered in the home network;
a re-registration to a roaming network where the apparatus is currently located; and
a transmitter configured to transmit an emergency call request to the roaming network.

40. The apparatus according to claim 39, wherein the transmitter is further configured to indicate a cause of an emergency call during re-registration to the roaming network.

41. The apparatus according to claim 39, wherein the transmitter is further configured to transmit the emergency call request to the nearest network element of the roaming network in which the mobile station is located.

42. The apparatus according to claim 41, further configured to establish an emergency call between the apparatus and the nearest network element of the roaming network.

43. The apparatus of claim 40, the transmitter is further configured to transmit an emergency call request to the home network before the register performs de-registration from the home network.

44. The apparatus of claim 43, further comprising a receiver configured to receive a rejection from the home network.

45. The apparatus of claim 44, the receiver is further configured to receive an indication to use the roaming network where the apparatus is located.

46. The apparatus of claim 45, the register is further configured to indicate a cause for an emergency call when performing re-registration to the roaming network.

47. The apparatus of claim 46, further configured to establish an emergency call between the apparatus and the nearest network element of the roaming network in which the apparatus is located.

48. A computer-readable storage medium encoded with instructions that, when executed by a computer perform:
de-registration from a home network of a worldwide interoperability for microwave access (WiMAX) network system;
re-registration to a roaming network;
sending an emergency call request to the roaming network; and
establishing an emergency call with a nearest network element of the roaming network.

49. The computer-readable medium encoded with instructions of claim 48, when executed by a computer further perform:
indicating a cause of an emergency call when re-registering to a roaming network.
